(19) United States
(12) Patent Application Publication
(10) Pub. No.: US 2022/0160489 A1
(43) Pub. Date: May 26, 2022

(54) ORAL HYGIENE DEVICES, SYSTEMS, AND METHODS

(71) Applicant: Phagenesis Limited, Manchester (GB)

(72) Inventor: Conor Mulrooney, Manchester (GB)

(21) Appl. No.: 17/455,608

(22) Filed: Nov. 18, 2021

Related U.S. Application Data
(60) Provisional application No. 63/198,909, filed on Nov. 20, 2020.

(51) Int. Cl. A61C 19/06; A61C 17/22; A61C 17/34; A61H 13/00; A61C 17/08

(52) U.S. Cl. CPC A61C 19/063; A61C 17/222; A61C 17/08; A61H 13/00; A61C 17/3481

(57) ABSTRACT

Oral hygiene devices, systems, and methods are disclosed herein. In some embodiments, the device comprises a disposable shaft configured to be releasably coupled to a reusable base. The shaft may include a head configured to engage an oral tissue and oral contents of a patient's oral cavity to dislodge one or more substances disposed on the oral tissue. In some embodiments, the shaft defines one or more lumens configured to transport a substance between the base of the device and the patient's oral cavity. The device can be configured to deliver a therapeutic agent to the patient's oral cavity to prevent and/or inhibit colonization of the oral cavity by pathogens. In particular embodiments, the device is configured to suction a substance out of the oral cavity and into the device to reduce a risk of the substance being aspirated into the patient's airways.

### CROSS-REFERENCE TO RELATED APPLICATION(S)

The present application claims the benefit of priority to U.S. Provisional Patent Application No. 63/198,909, titled ORAL HYGIENE DEVICES, SYSTEMS, AND METHODS, filed Nov. 20, 2020, which is incorporated by reference herein in its entirety.

### TECHNICAL FIELD

The present disclosure is directed generally to oral hygiene devices and associated systems and methods of use.

### BACKGROUND

Dysphagia is the condition whereby a patient has difficulty in swallowing or is unable to swallow safely. Dysphagia may be caused, for example, by stroke, neurodegenerative diseases, brain tumors or in some cases by other co-morbidities, such as respiratory disorders. It has been reported that between 7 and 10% of all adults older than 50 years of age present with clinically significant dysphagia. Of those over the age of 60, this increases to 14%. In total, 10 million Americans are evaluated each year in clinics and hospitals for swallowing difficulties. It has also been reported that over 51% of institutionalized elderly patients present with oropharyngeal dysphagia.

Patients with dysphagia have poor oral and nasal hygiene combined with ineffective clearance of pooled secretions from the area around the entrance to the airways. This can result in these secretions becoming contaminated with opportunistic pathogens. As patients with dysphagia often have ineffective airway protection, pathogenic secretions can enter the lower airways where they act as a locus for infection. Aspiration pneumonia is the main and most serious consequence of dysphagia. Oral hygiene is very hard to maintain in these patients, as many traditional oral hygiene procedures present an aspiration risk for patients with dysphagia. Consequently, gum disease and poor dental status are often seen, particularly with elderly stroke patients. This can result in the proliferation of opportunistic pathogens that migrate to the airways and act as a locus for infection. Other patients with dysphagia can present with ‘dry mouth’ due to reduced saliva production and this can also have an impact on oral health.

In view of the above, there remains a need for improved oral hygiene devices, systems, and methods.

### SUMMARY

The present technology relates to oral hygiene devices and associated systems and methods. In particular embodiments, the present technology comprises an oral hygiene device for cleaning an oral cavity of a patient. The device can be configured to dislodge a substance from an oral tissue of the patient, remove a substance from the patient's oral cavity, deliver a therapeutic agent to the patient's oral cavity, and/or stimulate the patient's oral tissues, for example. The subject technology is illustrated, for example, according to various aspects described below, including with reference to FIGS. 1-3. Various examples of aspects of the subject technology are described as numbered clauses (1, 2, 3, etc.) for convenience. These are provided as examples and do not limit the subject technology.

1. A device for cleaning an oral cavity of a human patient, the device comprising:
a base; and
a shaft having a first end portion configured to be releasably secured to the base and a second end portion comprising a head, the head having a massaging region and first and second apertures, the massaging region configured to engage tissue and/or contents of the oral cavity to dislodge one or more substances on the oral tissue, wherein the shaft defines:
   a first lumen extending between the first end portion of the shaft and a distal end corresponding to and/or in fluid communication with the first aperture, and
   a second lumen extending between the first end portion of the shaft and the second aperture,
wherein the first lumen is configured to be coupled to a pressure source and a reservoir containing a fluid, wherein the pressure source is configured to generate positive pressure in the first lumen to deliver the fluid from the reservoir through the first lumen and the first aperture to the patient's oral cavity, and
wherein the second lumen is configured to be coupled to a vacuum source, wherein the vacuum source is configured to generate negative pressure in the second lumen to draw a substance from the patient's oral cavity into the second lumen.

2. The device of Clause 1, wherein the vacuum source is integrated with the base such that the vacuum source and base comprise a self-contained unit.

3. The device of Clause 1, wherein the vacuum source is an external vacuum pump.

4. The device of any one of Clauses 1 to 3, wherein the massaging region comprises at least one of ridges, valleys, bumps, or bristles.

5. The device of any one of Clauses 1 to 4, wherein the base comprises a receptacle configured to be fluidly coupled to the second lumen and collect the substance drawn from the patient's oral cavity by the vacuum source.

6. The device of Clause 5, wherein the receptacle is releasably coupled to the base such that the receptacle is disposable.

7. The device of any one of Clauses 1 to 6, wherein the reservoir is integrated with the base such that the reservoir and the base comprise a self-contained unit.

8. The device of any one of Clauses 1 to 7, wherein the pressure source is integrated with the base such that the pressure source and the base comprise a self-contained unit.

9. The device of any one of Clauses 1 to 8, wherein the shaft is disposable and the base is reusable.

10. The device of any one of Clauses 1 to 9, wherein the fluid contained within the reservoir comprises a therapeutic agent configured to prevent or inhibit colonization of the oral cavity by a pathogen and/or alleviate symptoms of dry mouth.

11. The device of any one of Clauses 1 to 10, wherein:
the head comprises a first broad surface, a second broad surface, and a sidewall extending between the first and second broad surfaces,
the sidewall comprises two or more first apertures extending therethrough, and
the first broad surface and/or the second broad surface include the massaging region.

12. The device of Clause 11, wherein the first apertures are spaced apart along the sidewall.

13. The device of any one of Clauses 1 to 12, wherein the second aperture is disposed at a distal terminus of the device.

14. A system configured to clean an oral cavity of a human patient, the system comprising:
an oral hygiene device comprising:
   a base comprising a first compartment containing a fluid carrying a therapeutic agent and a second compartment separate from the first compartment; and
   a shaft having a first end portion configured to be releasably secured to the base and a second end portion comprising a head, the head having a massaging region and first and second apertures, the massaging region configured to engage tissue and/or contents of the oral cavity to dislodge one or more substances on the oral tissue, wherein the shaft defines:
      a first lumen extending between the first end portion of the shaft and a distal end corresponding to and/or in fluid communication with the first aperture, wherein the first lumen is configured to be fluidly coupled to the first compartment, and
      a second lumen extending between the first end portion of the shaft and the second aperture, wherein the second lumen is configured to be fluidly coupled to the second compartment;
a pressure source configured to be coupled to the first compartment, wherein the pressure source is configured to generate positive pressure in the first compartment and the first lumen to push the fluid carrying the therapeutic agent from the first compartment through the first lumen and the first aperture to the patient's oral cavity; and
a vacuum source configured to be coupled to the second compartment, wherein the vacuum source is configured to generate a negative pressure within the second compartment and the second lumen to draw a substance from the patient's oral cavity into the second aperture and through the second lumen into the second compartment.

15. The system of Clause 14, wherein the vacuum source is configured to draw the substance from the second compartment to the vacuum source.

16. The system of Clause 14 or Clause 15, wherein the second compartment is configured to capture particulate in the substance.

17. The system of any one of Clauses 14 to 16, wherein the pressure source is a manual pump.

18. The system of any one of Clauses 14 to 17, wherein the base comprises one or more actuators configured to activate the pressure source and/or the vacuum source.

19. The system of any one of Clauses 14 to 18, wherein the base comprises a vibration motor configured to vibrate the shaft of the oral hygiene device.

20. A method of cleaning an oral cavity of a human patient, the method comprising:
positioning a head of an oral hygiene device within the patient's oral cavity such that a disrupting surface of the head is positioned at or adjacent tissue and/or contents of the oral cavity;
moving the head along the tissue and/or contents while the disrupting surface engages with the oral tissue to dislodge a substance on the oral tissue;
generating a negative pressure within a first lumen of the device to pull the substance from the patient's oral cavity through the device to a waste container; and
generating a positive pressure within a second lumen of the device to deliver a fluid carrying a therapeutic agent from a reservoir through the device to the patient's oral cavity.

21. The method of Clause 20, further comprising generating a negative pressure within the first lumen of the device to pull the fluid from the patient's oral cavity through the device to the waste container after delivering the fluid to the patient's oral cavity.

22. The method of Clause 20 or Clause 21, wherein pulling the substance from the patient's oral cavity through the device to the waste container comprises pulling the substance into an opening in the head of the oral hygiene device.

23. The method of any one of Clauses 20 to 22, wherein delivering the fluid carrying the therapeutic agent to the patient's oral cavity comprises pushing the fluid through two or more openings in the head of the oral hygiene device.

24. The method of any one of Clauses 20 to 23, wherein the fluid carrying the therapeutic agent is delivered to the patient's oral cavity as a mist.

25. The method of any one of Clauses 20 to 24, wherein generating the negative pressure and/or generating the positive pressure comprises actuating one or more actuators on a base of the oral hygiene device.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 depicts an oral hygiene device in accordance with several embodiments of the present technology.

FIG. 2 depicts a shaft of an oral hygiene device in accordance with several embodiments of the present technology.

FIG. 3 depicts a base of an oral hygiene device in accordance with several embodiments of the present technology.

### DETAILED DESCRIPTION

Patients with dysphagia often have poor oral hygiene and ineffective clearance of secretions, which can contribute to the development of serious complications such as aspiration pneumonia. As many patients with dysphagia cannot manage their own oral hygiene, caregivers and healthcare providers are often tasked with caring for a dysphagic patient's oral hygiene. However, patients with dysphagia present unique challenges with regards to oral hygiene care. Such patients may have delicate oral tissues and the normal microbial flora of the patient's oral cavity is often replaced by opportunistic pathogens. Accordingly, caregivers and healthcare providers must be careful to avoid damaging the patient's oral tissues during oral hygiene care, as damaging the oral tissues can create a portal for a pathogen to enter the patient's blood stream and cause serious systemic infection. Preferably, the caregiver or healthcare provider would administer an antimicrobial agent to the patient to prevent or inhibit colonization of the patient's oral cavity by pathogens. Typically, such an agent would be administered as a mouthwash; however, mouthwash presents an aspiration risk for dysphagic patients and cannot be used. Moreover, pooled secretions and residual fluid from oral hygiene are also aspiration risks for dysphagic patients.

To address the foregoing challenges, the devices and systems disclosed herein are configured to gently dislodge substances within a patient's oral cavity, remove substances (e.g., pooled secretions, food debris, plaque, etc.) from the patient's oral cavity, and/or deliver a therapeutic agent to the patient's oral cavity. The devices and systems disclosed herein may also be configured to stimulate an oral tissue of the patient (e.g., the patient's gingiva) to promote health of the oral tissue. In some embodiments, the device comprises a shaft and a base configured to be releasably coupled to one another. The shaft can be disposable to prevent cross-contamination between patients and between treatments. The base can either be disposable or reusable. For example, a base incorporating more sophisticated functionalities, such as an automated pressure source integral with the base, may be reusable. A reusable base may comprise one or more disposable components. In some embodiments, the entire base is disposable.

In particular embodiments, the shaft comprises a head with a massaging region configured to engage tissues and/or contents of the oral cavity to dislodge a substance on an oral tissue and/or stimulate an oral tissue. Various features of the massaging region (e.g., texture, stiffness, etc.) can be configured such that engaging the patient's oral tissues with the massaging region is associated with a reduced risk of causing trauma the patient's oral tissues. In some embodiments, the device is configured to deliver a fluid carrying an antimicrobial agent through a lumen of the shaft to the patient's oral cavity to prevent or inhibit colonization of the oral cavity by one or more pathogens. In some embodiments, the device is configured to aspirate a substance from the patient's oral cavity into a lumen of the shaft to remove substances that create potential aspiration risks (e.g., dislodged debris, pooled secretions, excess antimicrobial agent, etc.).

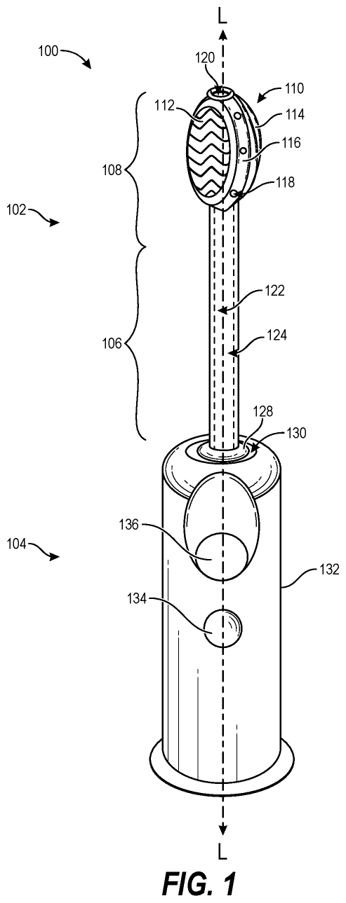

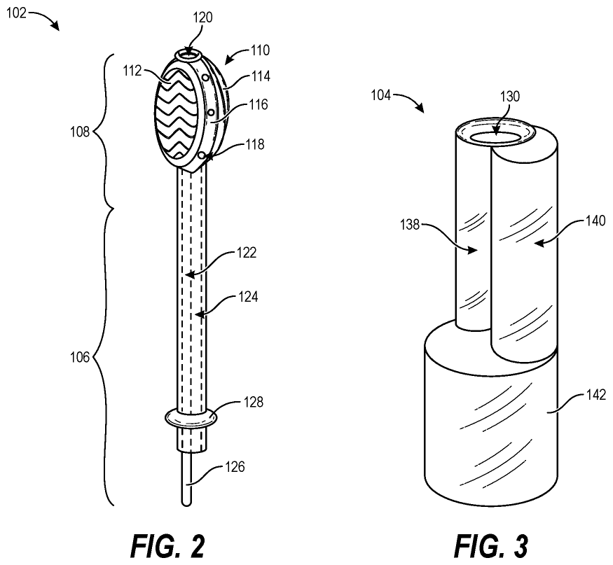

FIG. 1 depicts a device 100 configured for cleaning an oral cavity of a patient in accordance with several embodiments of the present technology. As shown in FIG. 1, the device 100 can include a shaft 102 and a base 104. The shaft 102 is shown isolated from the device 100 in FIG. 2 and the base 104 is shown isolated from the device 100 in FIG. 3. With reference to FIGS. 1-3 together, the shaft 102 can comprise a first portion 106 configured to be releasably secured to the base 104 and a second portion 108 comprising a head 110. The first portion 106 can comprise a substantially cylindrical, elongated shape as shown in FIGS. 1 and 2, or the first portion 106 can have another shape or configuration.

In some embodiments, the head 110 comprises a massaging region configured to engage one or more oral tissues (e.g., teeth, gingiva, tongue, palate, etc.) and/or contents of the patient's oral cavity to dislodge one or more substances disposed on an oral tissue. In some embodiments, the massaging region is configured to engage one or more oral tissues to stimulate blood flow in the one or more oral tissues. As such, the massaging region can comprise ridges, valleys, bumps, bristles, other textural features, or combinations thereof. The massaging region can have a stiffness sufficiently low such that the massaging region is configured to atruamatically engage the oral tissue. The massaging region can be a single massaging region or multiple massaging regions. In some embodiments, the multiple massaging regions each comprise the same properties and intended functions. Yet, in some embodiments each of the multiple massaging regions comprises a unique intended function and corresponding properties. For example, a first massaging region can comprise a greater stiffness such that the first massaging region is configured to apply a sufficient force to dislodge a substance from an oral tissue. A second massaging region can comprise a lower stiffness such that the second massaging region is configured to gently engage a gingival tissue of the patient to stimulate blood flow in the gingival tissue.

The head 110 can comprise a shape and a size configured to allow a user to engage various portions of the patient's oral cavity. According to some embodiments, for example as shown in FIGS. 1 and 2, the head 110 comprises a first broad surface 112, a second broad surface 114, and a sidewall 116 extending between the first and second broad surfaces 112, 114. The first and second broad surfaces 112, 114 can be generally ovular as shown in FIGS. 1 and 2. In other embodiments, the first and second broad surfaces 112, 114 can assume other shapes or configurations. The first broad surface 112, the second broad surface 114, and/or the sidewall 116 of the head 110 can include the massaging region.

The head 110 can comprise one or more apertures configured to transport substances between the device 100 and the patient's oral cavity. In some embodiments, the head 110 comprises one or more first apertures 118 and one or more second apertures 120. For example, as shown in FIGS. 1 and 2, the head 110 can comprise a plurality of first apertures 118 and a single second aperture 120. The plurality of first apertures 118 can be spaced apart along the sidewall 116 and/or the second aperture 120 can be disposed at a distal terminus of the device 100. The first and/or second apertures 120 can extend through the sidewall 116 of the head 110. In some embodiments, the first and/or second apertures 118, 120 extend through the first and/or second broad surfaces 112, 114. The one or more second apertures 120 can be disposed at a location away from the distal terminus of the device 100. In some embodiments, the head 110 comprises no first apertures 118 and/or no second apertures 120.

According to some embodiments, the shaft 102 comprises one or more lumens extending therethrough. For example, as shown in FIGS. 1 and 2, the shaft 102 can comprise a first lumen 122 and a second lumen 124. The first lumen 122 can extend between the first portion 106 of the shaft 102 and a distal end corresponding to one of the first apertures 118 and/or in fluid communication with one or more of the first apertures 118. In some embodiments, the distal end of the first lumen 122 can branch into two or more lumens that are each fluidly coupled to one of the first apertures 118. In some embodiments, the first apertures 118 are in fluid communication with a compartment within the head 110 of the shaft 102 and the distal end of the first lumen 122 is also in fluid communication with the compartment. The second lumen 124 can extend between the first portion 106 of the shaft 102 and a distal end corresponding to and in fluid communication with the second aperture 120. As will be described herein in greater detail, the first and second lumens 122, 124 of the shaft 102 can be configured to transport fluids and or substances between the device 100 and the patient's oral cavity. As shown in FIG. 2, in some embodiments the shaft 102 comprises a projection 126 extending along a longitudinal dimension L of the device 100. The first lumen 122 can extend through the projection 126 along the longitudinal dimension L such that the first lumen 122 extends beyond the first portion 106 of the shaft 102. As described herein, the first lumen 122 can be fluidically coupled to a reservoir of fluid within the base 104 of the device via the projection 126.

The shaft 102 can be configured to be releasably mechanically coupled to the base 104. For example, the projection 126 and/or at least a portion of the first portion 106 of the shaft 102 can be configured to be inserted into an opening 130 in a housing 132 of the base 104. In some embodiments, the first portion 106 of the shaft 102 includes an engagement feature 128 configured to secure the shaft 102 to the base 104. The engagement feature 128 can comprise a flange, shoulder, barb, ridge, bump, protrusion, magnet, screw, clip, or other suitable means for releasably securing the shaft 102 and base 104 to one another. According to some embodiments, for example as shown in FIG. 1, the engagement feature 128 can be configured to block the opening 130 to the housing 132 of the base 104 when the shaft 102 is secured to the base 104. Such configuration can prevent fluid leakage into and/or out of the base 104. In some embodiments, the base 104 includes the engagement feature 128 rather than the shaft 102, both the shaft 102 and the base 104 include an engagement feature 128, or neither the shaft 102 nor the base 104 includes an engagement feature 128. As depicted in FIG. 3, in some embodiments the base 104 comprises one or more structural features 142. The one or more structural features 142 can provide mechanical support, define a recess for electronics or subcomponents, extend a length of the base 104 for ergonomic purposes, etc.

The first and second lumens 122, 124 of the shaft 102 can be fluidly coupled to the base 104 of the device 100. The base 104 can contain and/or be configured to be coupled to one or more pressure sources and/or a fluid source to transport a substance between the device 100 and the patient's oral cavity via the first and second lumens 122, 124 of the shaft 102. In some embodiments, the base 104 includes a vibration source configured to vibrate the shaft 102 of the device 100. Vibration of the shaft 102 may facilitate dislodging a substance from the patient's oral tissues and/or stimulating the patient's oral tissues. In some embodiments, the base 104 comprises an actuator 134 configured to actuate the one or more pressure sources and/or the vibration source. The actuator 134 can comprise a button, a switch, a slider, etc. In some embodiments, the base 104 comprises a connector 136 configured to mechanically and/or electrically connect an external device (e.g., a pressure source, a power source, etc.) to the base.

According to some embodiments, for example as shown in FIG. 3, the base 104 comprises one or more compartments configured to contain and/or transport a substance. For example, the base 104 can comprise a first compartment 138 configured to contain a fluid to be delivered to the patient's oral cavity. The first compartment 138 can be configured to be fluidly coupled to the first lumen 122 of the shaft 102. As described herein, the projection 126 of the shaft 102, and therefore the portion of the first lumen 122 extending through the projection 126, can extend through the opening 130 in the housing 132 of the base 104 into the first compartment 138. In some embodiments, the fluid carries a therapeutic agent. The therapeutic agent may be any substance (or combination of substances) that provides a therapeutic effect in a patient in need thereof. In some embodiments, the therapeutic agent is an antimicrobial agent and/or an antibiotic agent and is configured to prevent and/or inhibit colonization of the oral cavity by a pathogen. The therapeutic agent can have antibacterial, antiviral, fungicidal, and/or antiprotozoal properties. The therapeutic agent can be microbicidal (e.g., configured to kill pathogens) and/or biostatic (e.g., configured to inhibit pathogen growth). In some embodiments, therapeutic agent is configured to alleviate the symptoms of dry mouth. Examples of such therapeutic agents include, but are not limited to, xylitol, carboxymethylcellulose, and hydroxyethyl cellulose. The first compartment 138 can be releasably coupled to the base 104 so that the first compartment 138 is disposable and/or replaceable. In some embodiments, the first compartment 138 is integrated with the base 104 such that the first compartment 138 and the base 104 comprise a self-contained unit.

The first compartment 138 can be fluidly coupled to a first pressure source. In some embodiments, the first pressure source is contained within the base 104 of the device 100. In some embodiments, the first pressure source is an external pressure source and the base 104 is configured to be coupled to the first pressure source (e.g., via connector 136). The first pressure source can be a manual pressure source or an automatic pressure source. The first pressure source can be configured to generate a positive pressure within the first compartment 138 and/or the first lumen 122 of the shaft 102 to deliver at least some of the fluid in the first compartment 138 through the first lumen 122 and the first apertures 118 to the patient's oral cavity. The fluid can be delivered to the patient's oral cavity as a mist or as a continuous stream of fluid. In some embodiments, the fluid is delivered such that the fluid coats the surfaces of the patient's oral cavity. For example, the first apertures 118 of the head of the shaft 102 can be spaced apart such that the fluid is pushed out of the first apertures 118 along multiple directions.

Referring still to FIG. 3, in some embodiments, the base 104 comprises a second compartment 140 fluidly coupled to the second lumen 124 of the shaft 102 and configured to receive a substance aspirated from the patient's oral cavity. The second compartment 140 can be configured to collect the aspirated substance and/or to serve as a fluid path between the second lumen 124 of the shaft 102 and an external device such as an external vacuum source or external waste container. In some embodiments, the second compartment 140 can include a filter and/or the second compartment 140 comprises a vacuum trap. In some embodiments, the second compartment 140 is releasably coupled to the base 104 so that the second compartment 140 is disposable and/or replaceable. In some embodiments, the second compartment 140 is integrated with the base 104 such that the second compartment 140 and the base 104 comprise a self-contained unit.

The second compartment 140 can be fluidly coupled to a second pressure source. In some embodiments, the second pressure source is contained within the base 104 of the device 100. In some embodiments, the second pressure source is an external pressure source and the base 104 is configured to be coupled to the second pressure source (e.g., via connector 136). The second pressure source can be a manual pressure source or an automatic pressure source. The second pressure source can be configured to generate a negative pressure (i.e., suction) within the second compartment 140 and/or the second lumen 124 of the shaft 102 to pull a substance from the patient's oral cavity into the second lumen 124. In some embodiments the second pressure source is configured to pull the substance from the second lumen 124 into the second compartment 140. As previously described, in some embodiments the second compartment 140 is configured to retain the substance. Additionally or alternatively, the second pressure source can be configured to pull the substance through the second compartment 140 and out of the device 100 (e.g., to an external container, to the second pressure source, etc.).

The first pressure source and the second pressure source can be separate devices or the same device. The pressure source(s) can include, for example, a power source and a controller including a processor coupled to a memory that stores instructions (e.g., in the form of software, code or program instructions executable by the processor or controller) for causing the power source to generate pressure within device according to certain parameters provided by the software, code, etc.

### CONCLUSION

Although many of the embodiments are described above with respect to devices, systems, and methods for cleaning an oral cavity of a patient with dysphagia, the technology is applicable to other applications and/or other approaches. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

As used herein, the terms “generally,” “substantially,” “about,” and similar terms are used as terms of approximation and not as terms of degree, and are intended to account for the inherent variations in measured or calculated values that would be recognized by those of ordinary skill in the art.

I/We claim:

1. A device for cleaning an oral cavity of a human patient, the device comprising:
a base; and
a shaft having a first end portion configured to be releasably secured to the base and a second end portion comprising a head, the head having a massaging region and first and second apertures, the massaging region configured to engage tissue and/or contents of the oral cavity to dislodge one or more substances on the oral tissue, wherein the shaft defines:
a first lumen extending between the first end portion of the shaft and a distal end corresponding to and/or in fluid communication with the first aperture, and
a second lumen extending between the first end portion of the shaft and the second aperture,
wherein the first lumen is configured to be coupled to a pressure source and a reservoir containing a fluid, wherein the pressure source is configured to generate positive pressure in the first lumen to deliver the fluid from the reservoir through the first lumen and the first aperture to the patient's oral cavity, and
wherein the second lumen is configured to be coupled to a vacuum source, wherein the vacuum source is configured to generate negative pressure in the second lumen to draw a substance from the patient's oral cavity into the second lumen.

2. The device of claim 1, wherein the vacuum source is integrated with the base such that the vacuum source and base comprise a self-contained unit.

3. The device of claim 1, wherein the vacuum source is an external vacuum pump.

4. The device of claim 1, wherein the massaging region comprises at least one of ridges, valleys, bumps, or bristles.

5. The device of claim 1, wherein the base comprises a receptacle configured to be fluidly coupled to the second lumen and collect the substance drawn from the patient's oral cavity by the vacuum source.

6. The device of claim 5, wherein the receptacle is releasably coupled to the base such that the receptacle is disposable.

7. The device of claim 1, wherein the reservoir is integrated with the base such that the reservoir and the base comprise a self-contained unit.

8. The device of claim 1, wherein the pressure source is integrated with the base such that the pressure source and the base comprise a self-contained unit.

9. The device of claim 1, wherein the shaft is disposable and the base is reusable.

10. The device of claim 1, wherein the fluid contained within the reservoir comprises a therapeutic agent configured to prevent or inhibit colonization of the oral cavity by a pathogen and/or alleviate symptoms of dry mouth.

11. The device of claim 1, wherein:
the head comprises a first broad surface, a second broad surface, and a sidewall extending between the first and second broad surfaces,
the sidewall comprises two or more first apertures extending therethrough, and
the first broad surface and/or the second broad surface include the massaging region.

12. The device of claim 11, wherein the first apertures are spaced apart along the sidewall.

13. The device of claim 1, wherein the second aperture is disposed at a distal terminus of the device.

14. A system configured to clean an oral cavity of a human patient, the system comprising:
an oral hygiene device comprising:
a base comprising a first compartment containing a fluid carrying a therapeutic agent and a second compartment separate from the first compartment; and
a shaft having a first end portion configured to be releasably secured to the base and a second end portion comprising a head, the head having a massaging region and first and second apertures, the massaging region configured to engage tissue and/or contents of the oral cavity to dislodge one or more substances on the oral tissue, wherein the shaft defines:
a first lumen extending between the first end portion of the shaft and a distal end corresponding to and/or in fluid communication with the first aperture, wherein the first lumen is configured to be fluidly coupled to the first compartment, and
a second lumen extending between the first end portion of the shaft and the second aperture, wherein the second lumen is configured to be fluidly coupled to the second compartment;
a pressure source configured to be coupled to the first compartment, wherein the pressure source is configured to generate positive pressure in the first compartment and the first lumen to push the fluid carrying the therapeutic agent from the first compartment through the first lumen and the first aperture to the patient's oral cavity; and
a vacuum source configured to be coupled to the second compartment, wherein the vacuum source is configured to generate a negative pressure within the second compartment and the second lumen to draw a substance from the patient's oral cavity into the second aperture and through the second lumen into the second compartment.

15. The system of claim 14, wherein the vacuum source is configured to draw the substance from the second compartment to the vacuum source.

16. The system of claim 14, wherein the second compartment is configured to capture particulate in the substance.

17. The system of claim 14, wherein the pressure source is a manual pump.

18. The system of claim 14, wherein the base comprises one or more actuators configured to activate the pressure source and/or the vacuum source.

19. The system of claim 14, wherein the base comprises a vibration motor configured to vibrate the shaft of the oral hygiene device.
